(19) United States
(12) Patent Application Publication
(10) Pub. No.: US 2013/0239026 A1
(43) Pub. Date: Sep. 12, 2013

(54) MULTI-DIMENSIONAL CONTENT DELIVERY MECHANISM

(71) Applicants: Mohammed Omar Farooque, Redmond, WA (US); Amalachandran Susainathan, Bothell, WA (US); Eric J. Hansen, Bellevue, WA (US); John C. Wyss, Redmond, WA (US); Amitava Majumdar, Redmond, WA (US); Jeniffer Lewis, Issaquah, WA (US)

(72) Inventors: Mohammed Omar Farooque, Redmond, WA (US); Amalachandran Susainathan, Bothell, WA (US); Eric J. Hansen, Bellevue, WA (US); John C. Wyss, Redmond, WA (US); Amitava Majumdar, Redmond, WA (US); Jeniffer Lewis, Issaquah, WA (US)

(73) Assignee: Microsoft Corporation, Redmond, WA (US)

(21) Appl. No.: 13/413,653

(22) Filed: Mar. 7, 2012

(51) Int. Cl. G06F 3/048

(52) U.S. Cl. 715/760; 715/764; 715/781

(57) ABSTRACT

A content delivery mechanism as a single object (also referred to as object bar) in a user interface. The object bar is a dynamic, context sensitive, adaptive multi-dimensional content delivery vehicle. The polymorphic nature of the object bar and the dynamic mechanism of delivering assistance content and controls (e.g., chat, videos, etc.) make it suitable for use in different application and customer scenarios. The object bar can be packed with N icons, in any order for any given context, with each icon designed to denote a specific dimension of information (a specific information type or intent type). The object bar can be docked on any side of the application view port and the user can chose to minimize it. When employed in an assistance environment for assistance content delivery and controls, a set of icons provides 360-degree perspective of the page.

### BACKGROUND

The ubiquitousness of computing devices translates into the widespread access to and control of information. Moreover, the capability to store vast amounts of information provides the opportunity to utilize this information in ways that can be beneficial. However, finding and providing the information for a given task and at a specific time can be problematic. Thus, businesses tend to expend resources to assistance users in not only learning new hardware and software systems, but also to work through problems in daily tasks.

For example, when introducing a new feature in a software program, a support team can experience an immediate escalation in call volume from customers using this feature. This not only consumes business resources, but also impacts the user/customer experience, since response time is typically also impacted. Moreover, feedback can be useful in resolving a problem, but is less efficient when requiring support resources. Accordingly, more performant techniques and solutions continue to be sought to address individual needs for problem resolution and task completion, for example.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a content delivery mechanism as a single object (also referred to as object bar) in a user interface. The object bar is a dynamic, context sensitive, adaptive multi-dimensional content delivery vehicle. The polymorphic nature (having multiple forms) of the object bar and the dynamic mechanism of delivering assistance content and controls (e.g., chat, videos, etc.) make it suitable for use in different application and customer scenarios.

The object bar can be packed with N icons (where N is an integer), in any order for any given context, with each icon designed to denote a specific dimension of information (a specific information type or intent type). The object bar can be docked on the right hand side of the application and the user can chose to minimize it. When employed in an assistance environment for assistance content delivery and controls, a set of icons provides 360-degree perspective of the page.

When used in help and assistance scenarios, for example, the object bar enables task completion, mitigation of support escalations, improves customer satisfaction, and enables customer feedback to optimize and influence content and product investments. At the backend, the object bar is capable of searching and delivering multi-dimensional advertisements.

The information architecture is decoupled from the control architecture, which means the object bar can be a vehicle to different information types and models, used as a content and information delivery vehicle, and reused in different products and different contexts.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary object, controls, and control icons that can be employed and dynamically changed for a given view.

FIG. 3 illustrates a system that uses the object as an information and advertisement delivery mechanism.

FIG. 4 illustrates a screenshot of an exemplary user interface of a web page, object with controls, and fly-out window.

FIG. 5 illustrates an exemplary diagram for control function operation.

FIG. 6 illustrates a method in accordance with the disclosed architecture.

FIG. 7 illustrates further aspects of the method of FIG. 6.

FIG. 8 illustrates an alternative method in accordance with the disclosed architecture.

FIG. 9 illustrates further aspects of the method of FIG. 8.

FIG. 10 illustrates a block diagram of a computing system that executes multi-dimensional content delivery in accordance with the disclosed architecture.

### DETAILED DESCRIPTION

The disclosed architecture is a content delivery mechanism as a single object (also referred to as object bar) in a user interface. The object bar is a dynamic, context sensitive, adaptive multi-dimensional content delivery vehicle. The polymorphic nature of the object bar and the dynamicism of delivering assistance content and controls (e.g., chat, videos, etc.) make the object bar suitable for use in different application and customer scenarios.

A tenet of a sound user assistance strategy is to integrate assistance content when and where needed, in the workflow. The object bar provides contextually-relevant assistance content within the application or service that seamlessly integrates into the user interface, as well as the user experience. Pop-up (also referred to herein as a fly-out window) help, chat, videos, and the object bar are examples of polymorphic controls. These controls are web-service driven and extend the HTML (hypertext markup language) document in which the controls are hosted.

Components that comprise the polymorphic embedded system/object bar include: a web-service-based vertical/data center, instrumentation for usage analysis, web APIs (application programming interfaces), publishing tools, controls, content schema (e.g., .xslt (an XML stylesheet format), .xsd (an XML schema file)), content files, and just-in-time user assistance (user interface).

The content sources for polymorphic controls are markup/XML (extensible markup language) files, formatted by a content schema, and served by web APIs.

The content files can be continuously updated to enable content replication. Publishing tools manage file metadata and provide on-demand publishing of content (to content replication servers) and thus, to the application or online service.

These controls support instructional videos and/or tutorials, in addition to other rich text and controls, thereby delivering up-to-date assistance content without having to redeploy code. Controls can be instrumented to enable monitoring the use of each control in detail, and then adjust on demand. This enables experimentation, optimization, and evolution.

The adaptive nature of the control and schema enable the injection of surveys, content, videos, chat, etc., on any of the controls on demand. Continuous implicit/explicit feedback from users gives the support teams an accurate way to understand and mitigate known problems. Rich contextual help accessible by the user enables the user to understand and use a product.

Existing architectures enable the derivation of user intent. As employed herein, user intent is a vehicle for advertisement delivery. User Intent is dynamic due to the web and content ability to influence the user as the user navigates or observes content. User intent is also oftentimes multi-dimensional, which dimensionality is not completely captured in a keyword, if taken literally. Semantic association also needs to be considered to determine dimensions and organize the information (e.g., in advertisements). As a search and advertisement engine, the user can now be given all the information in one search, rather than separate searches, one search for each specific intent.

Salient features of one implementation of the object bar include, but are not limited to:

Integration—the object bar can be a part of the host page and can surface as a series of fly-out windows, when a user selects on an icon in the bar.

Rich and polymorphic content schema—the content and user interface (UI) that appears in the fly-out windows are based on a markup language such as XML. A rendering engine and/or a translation layer transform the XML into UI and controls. Any of the fly-outs can deliver a rich experience that includes search, chat, videos, rich HTML, etc.

Contextual content and information—the object bar can be customized per view in the system in some of the following ways: number of icons in the bar can be adjusted dynamically or on demand; order of the icons can be adjusted on demand; content in the fly-outs can be changed on demand; and, content can be contextual to any service levels or categories (e.g., trusted user, power user, etc.).

Live icons—the user can be alerted as to icon state. The icons are multi-state, in that icon indicate to the user when new content is available, if the user has not clicked on the icon, and if the viewed state, for example. Cryptographic content hashes can be generated and maintained in a user profile store or cookie store, and compared with the hash of the incoming content. When the hash does not match, a different icon is selected to indicate that the content is new.

Highly adaptive, dynamic configurability—flexible XML markup and composition framework, combined with the ability to configure different bars (e.g., Help, Assistance, etc.) for different views, including ability to serve different content/UI within each view to different kinds of users, makes this object highly-adaptive and configurable.

Dynamic composition-based architecture—enables the definition of layout and UI using XML (decoupled from presentation), and enables these XML, markups to be published on demand for each product that uses this control.

Instrumentation—control is instrumented with web analytics and provides realtime user behavior with the object bar system.

Dynamic CSS (cascading style sheet)/HTML injection—a call from the object bar dynamically injects the CSS into the page header, thus enabling a configurable look-and-feel in a way that is decoupled from the host applications.

Design patterns in scripting (e.g., Jquery, a JavaScript™ library)—scripting can be employed to implement several design patterns, including singleton, facade, proxy, etc.

Reusable—the web API-based architecture scales across enterprise web products.

Following is a description of how to enable the code. For an application, there is a small amount of code to embed to enable the object bar. Once processing of the primary page (as a part of the master page) is initiated, an API is called to get the view/page-to-railbar configuration mapping. This configuration is cached on the application side for a predetermined TTL (time to live). The configuration is then parsed and looked-up to identify the content associated with the current view. If not already present in cache, the API is invoked to retrieve the content and cache it. Here, based on the configuration, a default fly-out window is shown to the user or shown when the user clicks on a specific icon. In other words, caching is employed to ensure a positive performance and render experience.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

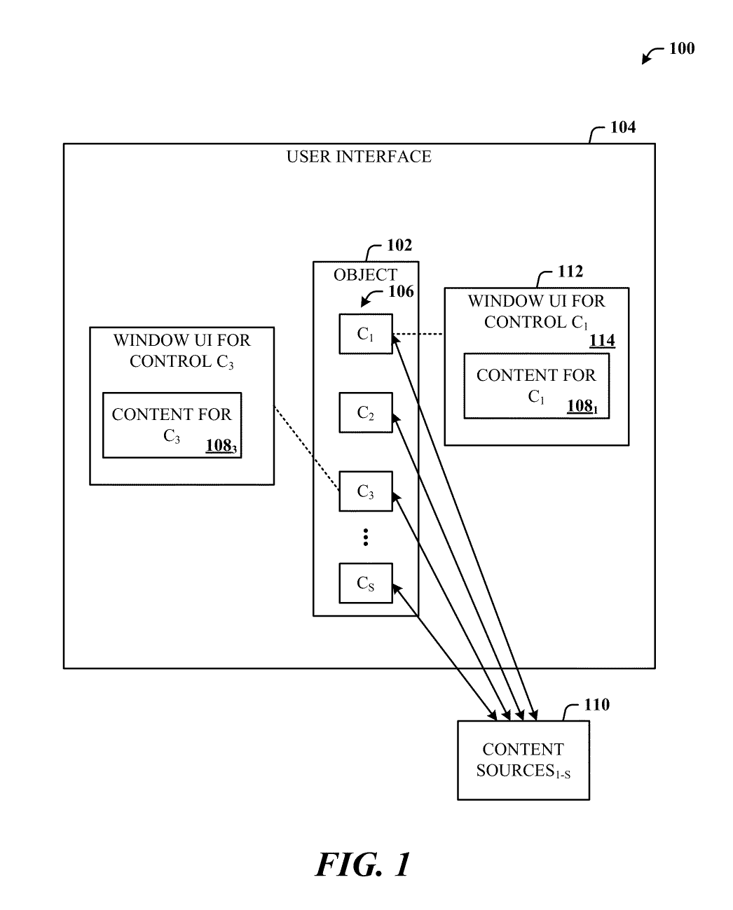

FIG. 1 illustrates a system 100 in accordance with the disclosed architecture. The system 100 can include a polymorphic object 102 of a user interface 104 that includes interactive controls 106 associated with multi-dimensional content (e.g., content 108₁ and content 108₃). The controls 106 map to content of sources 110 based on user intent, and interaction with a control (e.g., a control C₁) facilitates presentation of the corresponding content (e.g., content 108₁) in a fly-out window (e.g., a window 112 for the control C₁). Each fly-out window has a specific window user interface (UI) that is defined by a markup language. Thus, the window 112 has a window UI 114 for the given content and presentation.

The object 102 is agnostic of content dimension (e.g., text, image, video, chat, search result(s), etc.). The controls 106 of the object 102 are driven by a web service. The controls 106 are presented as part of the object and can dynamically changes according to changes in the user intent as derived by interaction with network sites (related to the content sources 110). As previously indicated, the content (e.g., content 108₁) is presented as a fly-out window (e.g., window 112) proximate the object 102 (and visually indicated (e.g., an arrow or other type of graphical connector) as related to the corresponding control, e.g., control C₁). The content (e.g., content 108₁) and user interface (e.g., UI 114) of the fly-out window (e.g., window 112) is of a markup language. In other words, the layout is defined by a markup language such as XML (extensible markup language).

The controls 106 are multi state to indicate at least one of new content, select state, or view state. That is, first state (graphical emphasis visually perceived as a first color) of a control C₁ can indicate that new content is available upon selection of the control C₁, a second state (of a second color) can indicate the current selected state, and yet a third state (of a third color) can indicate a viewed state where the content mapped to the control has already been viewed.

The object 102 can be customized per view via the number of controls 106, order of the controls 106, content in the associated fly-out (window), and/or content for a service level (e.g., trusted user, power user, etc.). Additionally, the object 102 can be dynamically configured for different views and different content.

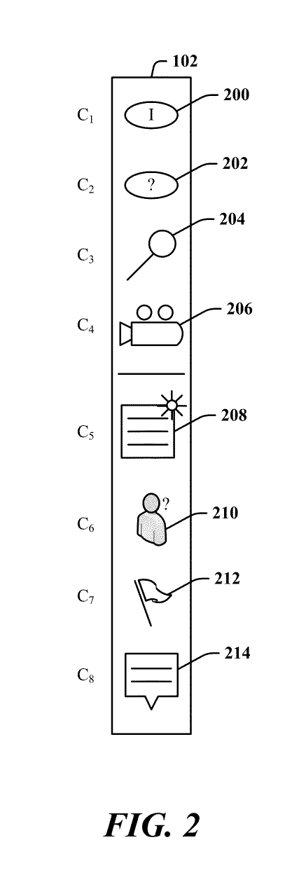

FIG. 2 illustrates an exemplary object 102, controls, and control icons that can be employed and dynamically changed for a given view. The object, controls, and icons are described here as applied to advertising; however, it is to be understood that this applies to any desired context.

A first icon 200 associated with control C₁ can be a description control (“About this page”) that describes the page. When used with advertising, this control can orient advertisers to essential workflow or primary goals to be achieved on this page. A second icon 202 associated with a control C₂ can be an instructional control (“How do I”). This control lists and provides numbered steps for key tasks advertisers can perform on this page.

A third icon 204 associated with a control C₃ can be for search initiation (“Search Content”). This gives advertisers quick access to help topics, and applies the search across a network-based content store. A fourth icon 206 associated with a control C₄ can be for video access (“Video”), which displays of a list of contextually relevant videos. A fifth icon 208 associated with a control C₅ can be for accessing the latest feature updates (“What's New”). This lists and describes the latest features and updates on the page. A yellow icon can signal fresh content, and turns blue after the content is viewed.

A sixth icon 210 associated with a control C₆ can be for accessing the most-asked questions (“Everybody's Asking”). This lists die most-asked questions about the tasks and goals on the page. The questions can expand to display answers. A seventh icon 212 associated with a control C₇ can be for known issues (“Known Issues”). This lists known problems and troubleshooting solutions for this page. If there are no issues, the icon is not displayed. An eighth icon 214 associated with a control C₈ can be for chat (“Talk to us (chat)”). This gives advertisers quick access to a live chat support representative.

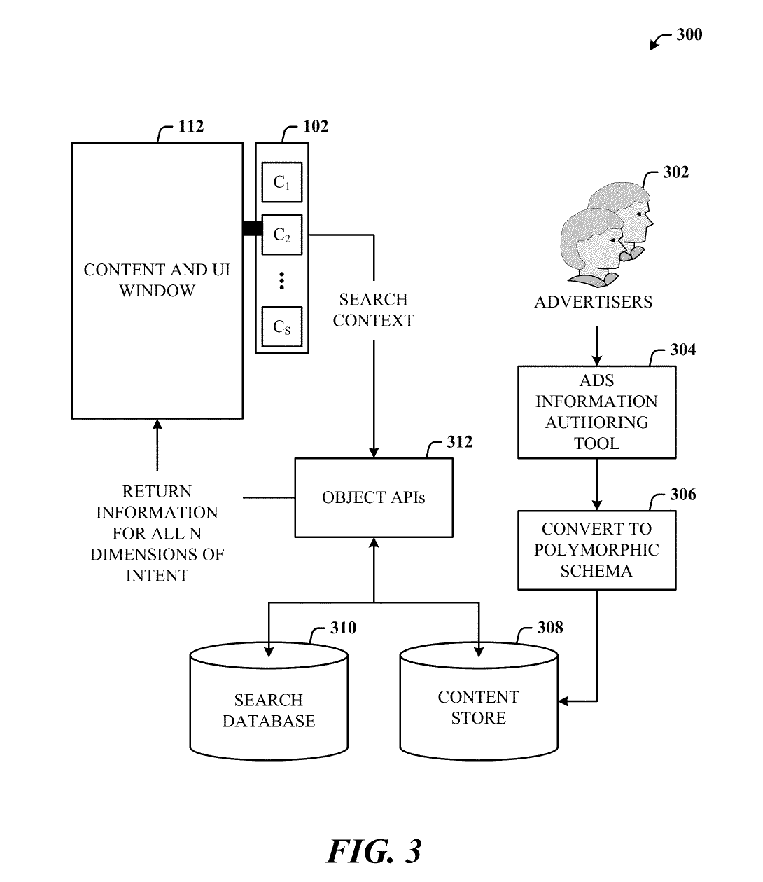

FIG. 3 illustrates a system 300 that uses the object 102 as an information and advertisement delivery mechanism. Each icon associated with a control (e.g., control C₁) represents one dimension of user intent or information intent, depending on the context in which the control is being used. In this example, implementation, for advertising, advertisements are served on a search site, the video dimension is shown as the optimum as determined by match, and presented in the fly-out by default. Note that each fly-out (pop-up) can be a rail of advertisements and/or links. Thus, the capability is provided pack a rail of advertisements and/or links in each intent and let the user select it, if the user chooses to see that intent. Intent is not a static entity, but is dynamic and is influenced as the user interacts with the web.

In operation, advertisers 302 author advertising information using an authoring tool, as indicated at 304. At 306, the advertising information is converted to a polymorphic schema for compatibility with the polymorphic object 102. The schema is then stored in a content store 308 (e.g., for the information and the advertisements). A search database 310 maps context to content and indexes these mappings (which in this example, can be advertisements).

When the page is loaded, the user has not yet interacted with the object 102, and there is much context that can be obtained. The URL is context, the content within the webpage is context, and essentially, any user interaction is context. This context is now available to the object 102. A search request is sent from the object 102 to search the database 310 via APIs 312. Additionally, the APIs 312 facilitate access to the content store 308 to retrieve content such as assistance content, advertisements, videos, text, etc. The mappings of the context to the specific types of content are then returned through the APIs 312 for all dimensions of intent of controls for the object 102. In this example, the content presented in the window 112 can be a video, as initiated via a selected control C₂, for example.

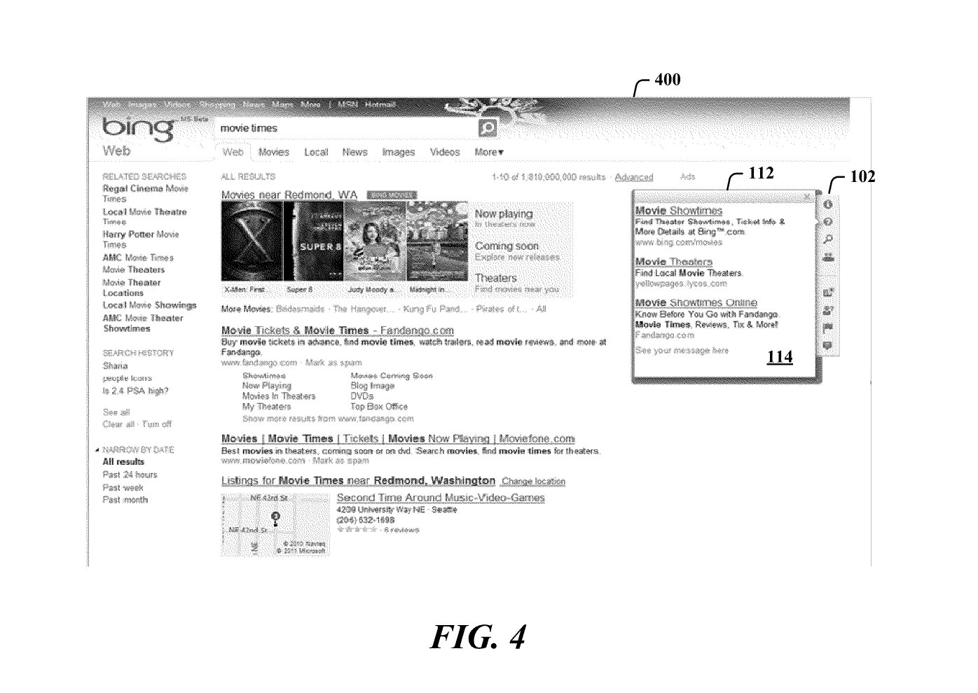

FIG. 4 illustrates a screenshot of an exemplar) user interface of a web page 400, object 102 with controls, and fly-out window 112. The fly-out window 112 has its own window UI 114 and content.

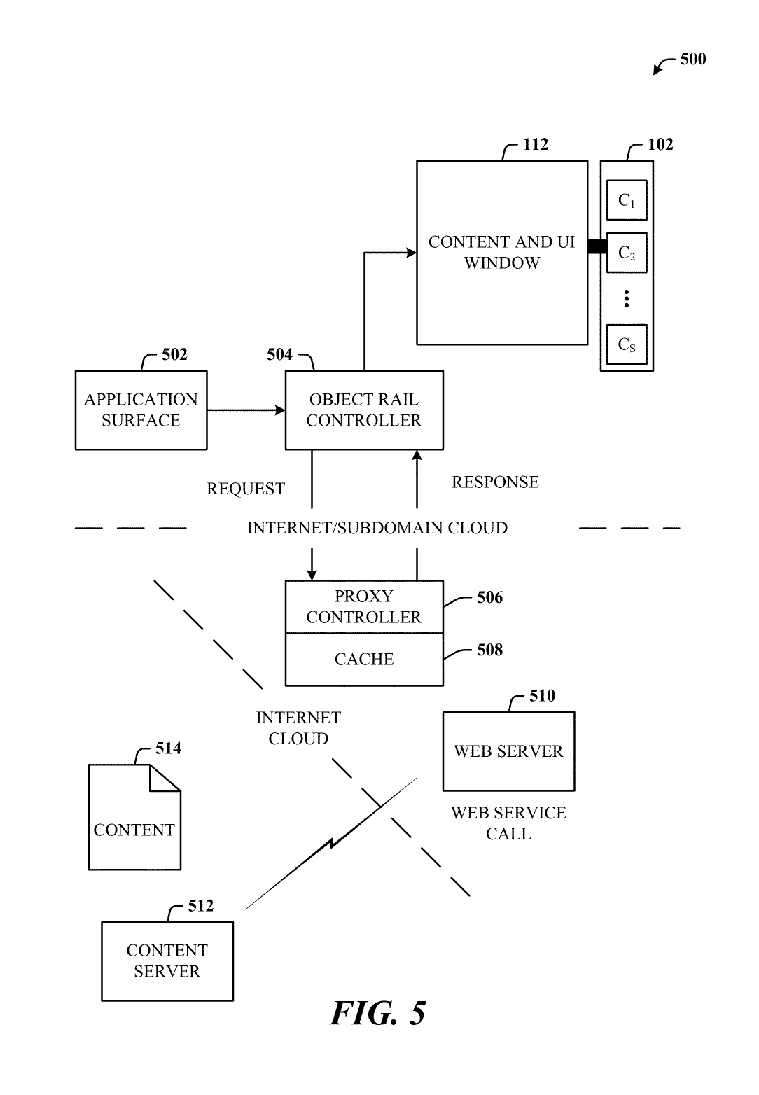

FIG. 5 illustrates an exemplary diagram 500 for control function operation. When the user opens a browser application, the object 102 is presented on the application UI (the application surface 502). The application surface 502 and object 102 interface to an object rail controller 504, which handles requests to a proxy controller 506 and associated server cache 508. The request can be satisfied directly from the cache 508 back to the rail controller 504, and then to the object 102. If not cached, the request is processed to a web server 510, which places a web service call to a content server 512 for content 514 that has already been converted into a schema suitable for use with the object 102 and presentation in the fly-out window 112

The controls leverage (utilize) the schema to transform content to UI and content controls in the rendering window 112. The content can be fetched from an advertisement/content store (e.g., store 308) and other advertisement applications via an AJAX (asynchronous JavaScript and XML) call on the web service/APIs provided. The content then renders in the host window 112 and, the look-and-feel (user experience) is dictated by the content code.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

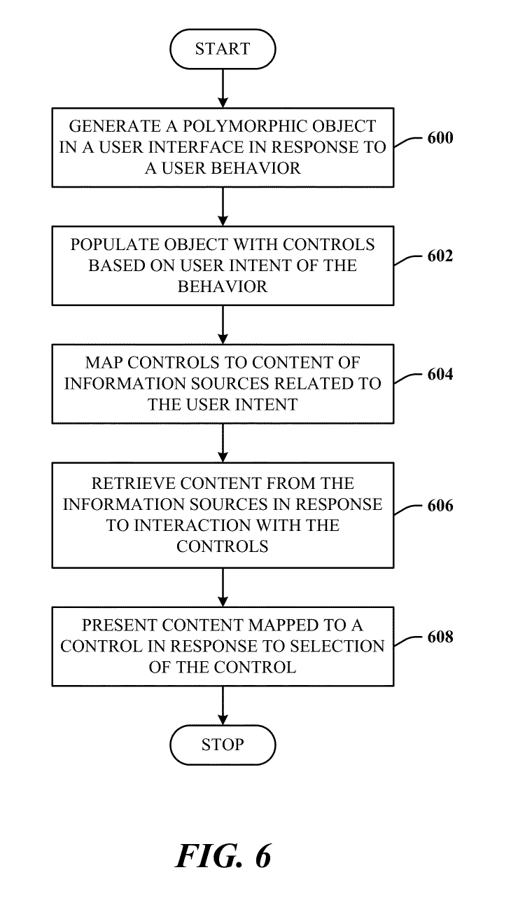

FIG. 6 illustrates a method in accordance with the disclosed architecture. At 600, a polymorphic object is generated in a user interface in response to a user behavior. At 602, the object is populated with controls based on user intent of the behavior. At 604, the controls are mapped to content of information sources related to the user intent. At 606, the content is retrieved from the information sources in response to interaction with the controls. At 608, content mapped to a control is presented in response to selection of the control.

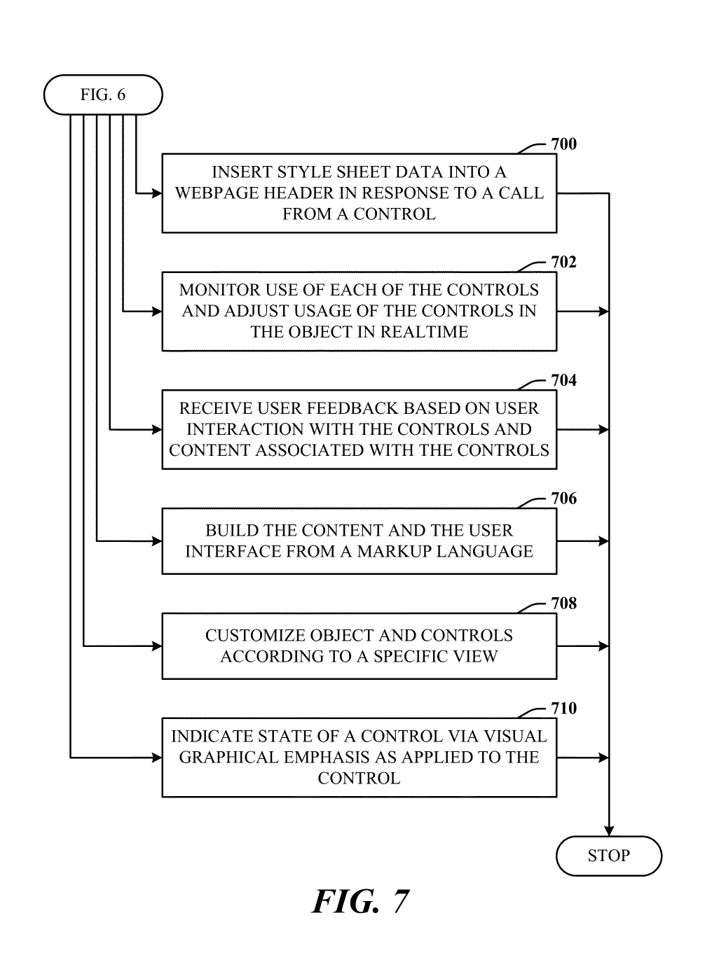

FIG. 7 illustrates further aspects of the method of FIG. 6, Note that the flow indicates that each block can represent a step that can be included, separately or in combination with other blocks, as additional aspects of the method represented by the flow chart of FIG. 6. At 700, style sheet data is inserted into a webpage header in response to a call from a control. At 702, use of each of the controls is monitored and usage of the controls is adjusted in the object in realtime. At 704, user feedback is received based on user interaction with the controls and content associated with the controls. At 706, the content and the user interface are built from a markup language. At 708, the object and controls are customized according to a specific view. At 710, state of a control is indicated via visual graphical emphasis as applied to the control.

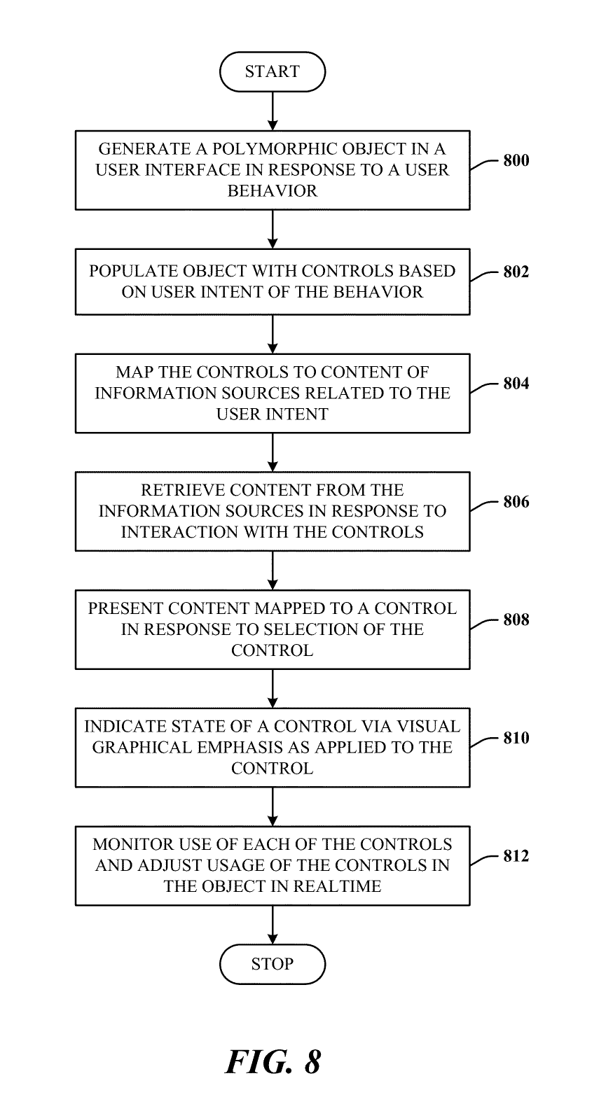

FIG. 8 illustrates an alternative method in accordance with the disclosed architecture. At 800, a polymorphic object is generated in a user interface in response to a user behavior. At 802, the object is populated with controls based on user intent of the behavior. At 804, the controls are mapped to content of information sources related to the user intent. At 806, the content is retrieved from the information sources in response to interaction with the controls. At 808, the content mapped to a control is presented in response to selection of the control. At 810, state of a control is indicated via visual graphical emphasis as applied to the control. At 812, use of each of the controls is monitored and usage of the controls in the object is adjusted in realtime.

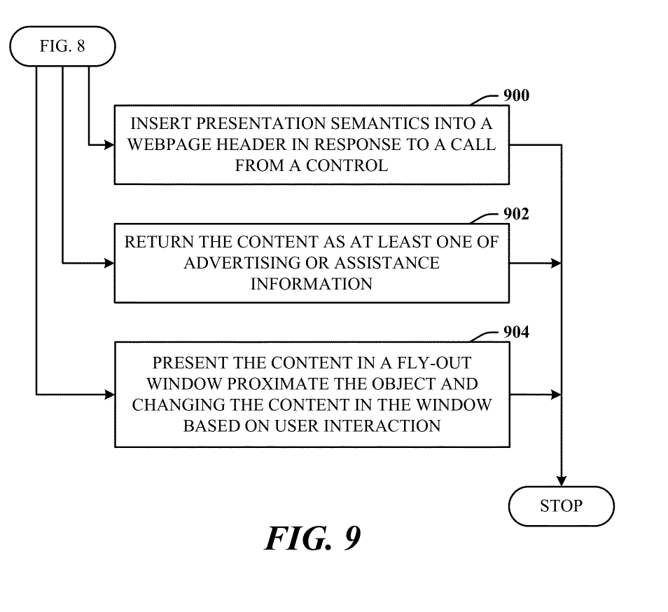

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, presentation semantics are inserted into a webpage header in response to a call from a control. At 902, the content is returned as at least one of advertising or assistance information. At 904, the content is presented in a fly-out window proximate the object and changing the content in the window based on user interaction.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

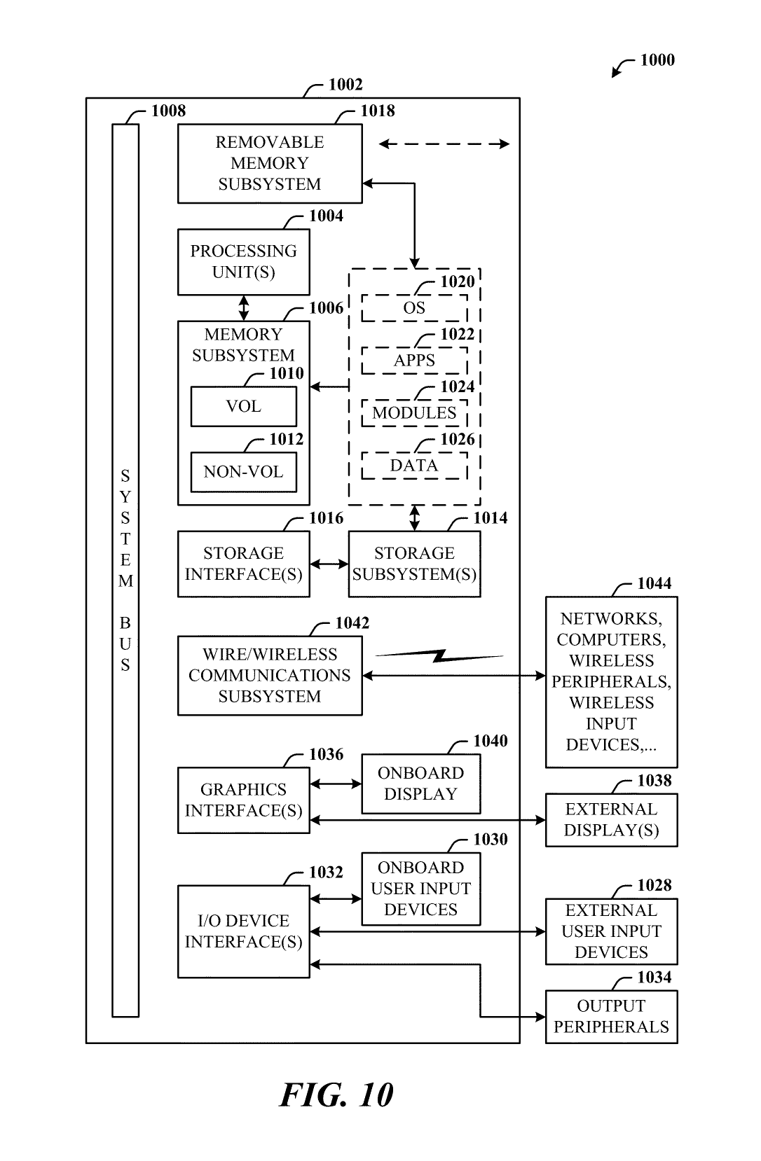

Referring now to FIG. 10, there is illustrated a block diagram of a computing system 1000 that executes multi-dimensional content delivery in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystems's) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the object 102 of FIG. 2, entities and components of the system 300 of FIG. 3, entities and components of the user interface page 400 of FIG. 4, the diagram 500 of FIG. 5, and the methods represented by the flowcharts of FIGS. 6-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse, and/or speech recognition subsystem for voice interaction. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example.

These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a polymorphic object of a user interface that includes interactive controls associated with multi-dimensional content, the controls map to content of sources based on user intent, and interaction with a control facilitates presentation of the corresponding content; and
a processor that executes computer-executable instructions associated with the object.

2. The system of claim 1, wherein the object is agnostic of content dimension.

3. The system of claim 1, wherein the controls of the object are driven by a web service.

4. The system of claim 1, wherein the controls presented as part of the object and dynamically change according to changes in the user intent as derived by interaction with network sites.

5. The system of claim 1, wherein the content is presented as a fly-out window proximate the object.

6. The system of claim 5, wherein the content and user interface of the fly-out window is of a markup language.

7. The system of claim 1, wherein the controls are multistate to indicate at least one of new content, select state, or view state.

8. The system of claim 1, wherein the object is customized per view via at least one of number of controls, order of the controls, content in a fly-out, or content for a service level.

9. The system of claim 1, wherein the object is dynamically configured for different views and different content.

10. A method, comprising acts of:
generating a polymorphic object in a user interface in response to a user behavior;
populating the object with controls based on user intent of the behavior;
mapping the controls to content of information sources related to the user intent;
retrieving the content from the information sources in response to interaction with the controls;
presenting content mapped to a control in response to selection of the control; and
utilizing a processor that executes instructions stored in memory to perform at least one of the acts of generating, populating, mapping, retrieving, or presenting.

11. The method of claim 10, further comprising inserting style sheet data into a webpage header in response to a call from a control.

12. The method of claim 10, further comprising monitoring use of each of the controls and adjusting usage of the controls in the object in realtime.

13. The method of claim 10, further comprising receiving user feedback based on user interaction with the controls and content associated with the controls.

14. The method of claim 10, further comprising building the content and the user interface from a markup language.

15. The method of claim 10, further comprising customizing the object and controls according to a specific view.

16. The method of claim 10, further comprising indicating state of a control via visual graphical emphasis as applied to the control.

17. A method, comprising acts of:
generating a polymorphic object in a user interface in response to a user behavior;
populating the object with controls based on user intent of the behavior;
mapping the controls to content of information sources related to the user intent;
retrieving the content from the information sources in response to interaction with the controls;
presenting the content mapped to a control in response to selection of the control;
indicating state of a control via visual graphical emphasis as applied to the control;
monitoring use of each of the controls and adjusting usage of the controls in the object in realtime; and
utilizing a processor that executes instructions stored in memory to perform at least one of the acts of generating, populating, mapping, retrieving, presenting, indicating, or monitoring.

18. The method of claim 17, further comprising inserting presentation semantics into a webpage header in response to a call from a control.

19. The method of claim 17, further comprising returning the content as at least one of advertising or assistance information.

20. The method of claim 17, further comprising presenting the content in a fly-out window proximate the object and changing the content in the window based on user interaction.
